(19) United States
(12) Patent Application Publication
(10) Pub. No.: US 2026/0016805 A1
(43) Pub. Date: Jan. 15, 2026

(54) Method and Process to Monitor Parallel Work on a Structure

(71) Applicant: The Boeing Company, Arlington, VA (US)

(72) Inventors: Veniamin Stryzheus, Kent, WA (US); Bryan Cass Bramwell, Seattle, WA (US)

(21) Appl. No.: 18/769,989

(22) Filed: Jul. 11, 2024

(51) Int. Cl. G05B 19/406; B23Q 17/20; G01P 15/00

(52) U.S. Cl. CPC G05B 19/406; B23Q 17/20; G01P 15/00

(57) ABSTRACT

Methods and processes to monitor parallel work on a structure. One method includes monitoring a structure while parallel work is being performed on the structure. The method includes acquiring data at a plurality of points on the structure while parallel work is being performed on the structure. After the data is acquired, the data is analyzed to determine the movement of the structure. An alert is sent when the movement of the structure exceeds a threshold.

### TECHNOLOGICAL FIELD

The present disclosure relates generally to the field of manufacturing structures and, more specifically, to monitoring the structures during manufacturing and detecting motion.

### BACKGROUND

Large structures such as but not limited to industrial equipment and vehicles such as aircraft are manufactured using a variety of different processes. The processes can be automated and performed by various robotic machines and/or can be manual processes performed by humans. Example processes used during manufacturing include but are not limited to drilling, fastening, and assembly. Because of the relatively large size of the structures, the manufacturing process includes parallel work being simultaneously performed on the structure. For example, holes can be drilled in a first section of the structure while components are being attached with fasteners to a second section of the structure. The simultaneous processing can occur for various reasons, including but not limited to production rate schedules, availability of machinery, and delivery schedules.

The parallel work creates a challenge when working on a structure. The work being performed on one section of the structure can cause movement in one or more different sections of the structure. The movement can include but is not limited to vibration, bending, and deformation. The movement of the structure at the other sections can cause issues with the manufacturing. For example, work on a first section can cause a vibration in a second section that can cause holes to be drilled in the wrong locations and/or have the wrong size.

A system is needed to monitor the movement of the structure when parallel work is being performed. The system can be configured to determine the extent of movement. The system may also be configured to respond with the proper action to limit the impact on the structure.

### SUMMARY

One aspect is directed to a method of monitoring a structure while parallel work is being performed on the structure. The method comprises: acquiring data at a plurality of points on the structure while the parallel work is being performed on the structure; analyzing the data and determining the movement of the structure; and sending an alert when the movement of the structure exceeds a threshold.

In another aspect, the method further comprises: acquiring the data at a plurality of points at a first section and a second section of the structure; analyzing the data and determining the movement of the first section of the structure; and sending the alert when the movement of the first section of the structure exceeds the threshold.

In another aspect, the method further comprises after sending the alert stopping the work that is being performed at the first section of the structure and continuing the work that is being performed at the second section.

In another aspect, the method further comprises placing targets at the points on the structure and acquiring the data at the plurality of points using the targets.

In another aspect, the method further comprises calculating an acceleration and a frequency of the movement of the structure.

In another aspect, the method further comprises calculating the frequency through a Fast Fourier Transform and calculating a Power Spectral Density.

In another aspect, the threshold is a first threshold and further comprising comparing the movement to the first threshold and a plurality of escalating thresholds and determining which of the one or more thresholds is exceeded.

In another aspect, the method further comprises: subsequently determining an issue within the structure caused during the parallel work; and identifying a cause of the issue based on the movement data.

In another aspect, sending the alert comprises preventing the work from being performed at the first section.

One aspect is directed to a method of monitoring a structure. The method comprises: acquiring data at a first section of the structure while work is being performed on both the first section and at least one additional section of the structure; determining movement of the first section of the structure based on the data; determining that the movement of the first section exceeds a threshold; and sending an alert when the movement of the first section exceeds the threshold.

In another aspect, the at least one additional section is spaced away from the first section on the structure.

In another aspect, determining the movement of the first section of the structure comprises determining a vibration of the first section.

In another aspect, the method further comprises: calculating an acceleration of points in the first section; and calculating a power spectral density of the points in the first section.

In another aspect, the method further comprises sensing the movement of the first section at a point at the first section.

In another aspect, sending the alert comprises displaying a signal on an indicator that is positioned at the first section.

One aspect is directed to a control unit that monitors movement of a structure. The control unit comprises processing circuitry and memory circuitry with programming instructions that are executable by the processing circuitry whereby control unit is configured to: acquire data at a plurality of points at a first section and one or more additional sections of the structure while parallel work is being performed on the first section and the one or more additional sections; analyze the data to determine the movement of the structure within the first section of the structure; determine that the movement of the structure within the first section exceeds a threshold; and cause a change in the work that is being performed on the first section.

In another aspect, the control unit is further configured to calculate a frequency of the movement of the first section, and calculate a power spectral density of the acceleration.

In another aspect, the control unit is further configured to send an alert after determining that the movement of the structure within the first section exceeds the threshold.

In another aspect, the control unit is further configured to calculate an acceleration and a frequency of the movement of the structure within the first section.

In another aspect, the control unit is further configured to: determine an issue with the work that has been performed on the first section; determine the movement data that was recorded while the work was being performed on the first section; and determine a cause of the issue based on the movement data.

The features, functions and advantages that have been discussed can be achieved independently in various aspects or may be combined in yet other aspects, further details of which can be seen with reference to the following description and the drawings.

### BRIEF DESCRIPTION OF THE DRAWINGS

FIG. 1 is an isometric view of a structure sized to enable parallel work.

FIG. 2 is an isometric view of an aircraft.

FIG. 3 is a flowchart diagram of a method of monitoring a structure during parallel work.

FIG. 4 is a schematic diagram of a network having laser trackers and targets to collect data from a structure.

FIG. 5 is a flowchart diagram of a method of monitoring movement of a structure.

FIG. 6 is a plot graph of movement of a structure displayed in displacement over time.

FIG. 7 is a plot graph of movement of a structure displayed in acceleration over time.

FIG. 8 is a plot graph of movement of an acceleration power spectral density displayed in acceleration over time.

FIG. 9 is a flowchart diagram of a method of monitoring movement of a structure.

FIG. 10 is a schematic diagram of parallel work being performed on multiple sections of a structure.

FIG. 11 is a schematic diagram of a control unit.

### DETAILED DESCRIPTION

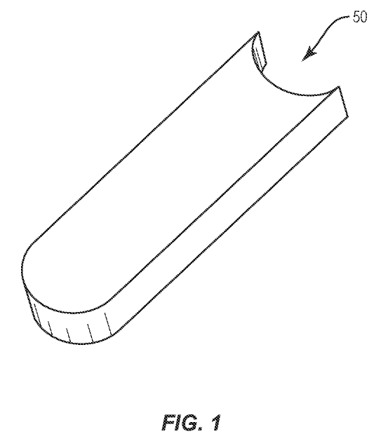

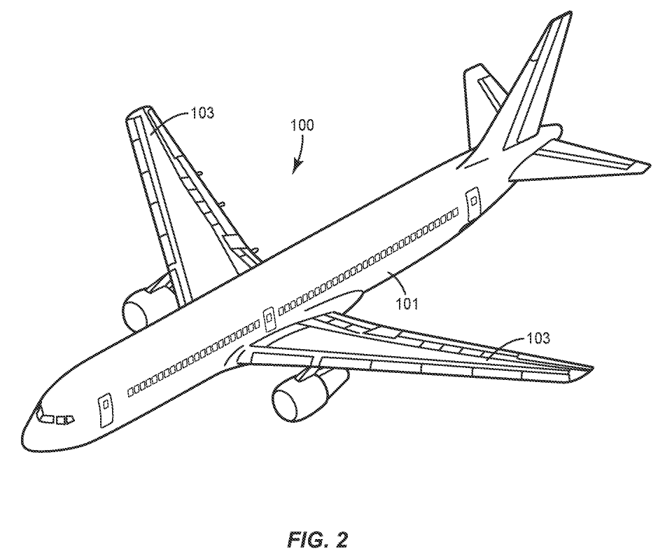

FIG. 1 illustrates an example of a structure 50 applicable for use with the parallel work monitoring of the present disclosure. The structure 50 is considered “large” because it is sized to enable two or more processes to be performed in parallel. The structure 50 can include a variety of different shapes and sizes and be constructed from a variety of different materials. The structure 50 can have a one-piece integral construction or can include two or more different sections that are connected together. One example of a structure 50 is an entirety or a section of an aircraft 100 as illustrated in FIG. 2. Examples of structures 50 within the context of an aircraft 100 include but are not limited to a portion or entirety of a fuselage 101 or wing 103.

Parallel work includes two or more processes that are performed simultaneously on the structure 50. For example, parallel work includes a first process (e.g., drilling) and a simultaneous second process (e.g., fastening). In another example, the parallel work includes three or more simultaneous processes. A section of the structure 50 can include different shapes and sizes. In some examples, a section is a discrete point. The different sections can be positioned at various different relative locations. In some examples, different sections are spaced apart on the structure 50. In other examples, the different sections are positioned adjacent to one another.

The parallel work monitoring determines whether a process is affected when one or more other processes that are simultaneously occurring on the structure 50 induce an extent of movement to impact the process. For example, a drilling operation that requires precise positioning of a drill bit may be adversely affected by a hammering process that is simultaneously occurring. A process can be affected when there is various types of movement. Examples of movement include but are not limited to displacement (x-direction, y-direction, z-direction, xyz magnitude), velocity (x-direction, y-direction, z-direction, xyz magnitude), and acceleration (x-direction, y-direction, z-direction, xyz magnitude).

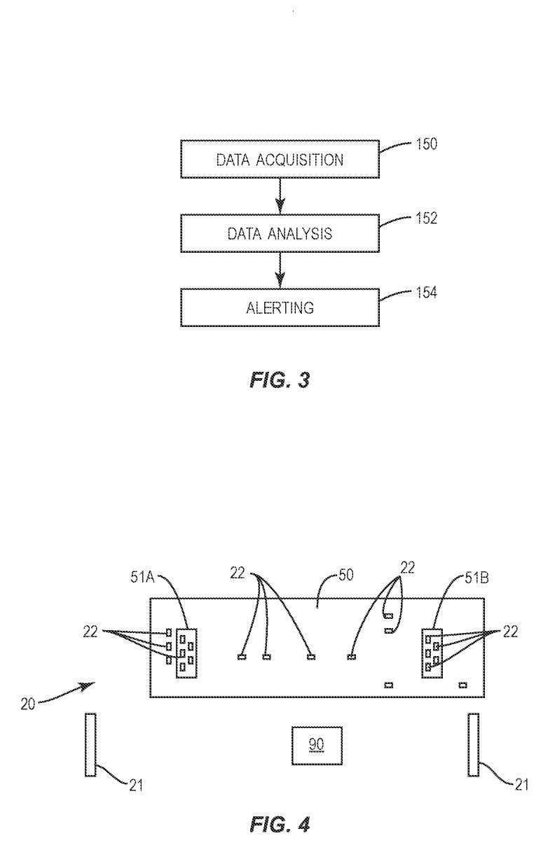

The processes and methods to evaluate the effects of the parallel work are generally shown in FIG. 3. The method includes initially acquiring movement data of the structure 50 (block 150). The data is acquired while the multiple different processes are being performed on the structure 50. The acquired data is analyzed to determine the movement (block 152). Depending upon the extent of movement, one or more alerts are sent (block 154). The alerts indicate that there is an issue caused by the parallel work.

The parallel work monitoring collects data regarding the movement of the structure 50. FIG. 4 illustrates an example of a structure 50 in which a first process is being performed at a first section 51A and a second process is being simultaneously performed at a second section 51B. In some examples, the data is collected at points throughout the structure 50. In other examples, data is collected in a more limited manner. Examples include but are not limited to collecting data just from within the sections where the processes are being performed, collecting data within just one section, and collecting data just at points within the sections and directly between the sections. In some examples, the limited data collection occurs in the one or more sections 51 where precise processes are being performed and with no data collection in the one or more sections 51 where more coarse processes are being performed. For example, data is collected where precise drilling is occurring, but data is not collected in sections where cabling is being manually mounted to the structure 50.

The data is collected through one or more sensing networks 20. In some examples as schematically illustrated in FIG. 4, the sensing network 20 includes one or more laser trackers 21 and targets 22. The targets 22 are positioned at known positions on the structure 50. The laser trackers 21 emit a laser beam, such as a Helium Neon laser beam, that is reflected back from the targets 22. In some examples, the targets 22 are spherically mounted retroflectors (SMR). The laser trackers 21 include encoders and sense the position of the reflected laser beam. The laser trackers 21 are configured to determine the three-dimensional positions of the targets 22 as the distance between the laser tracker 21 and target 22 and the azimuth and zenith angles of the angular encoders. One specific laser tracker 21 is a Leica Absolute Tracker Model AT960 available from Hexagon AB.

In some examples, the targets 22 are artifacts that are attached to the structure 50. Examples include but are not limited to designs that are printed on the structure, and small target objects that are secured to the structure 50. The artifacts are detected by the laser trackers 21 to determine movement of the structure 50 at the targets 22. In some examples, the targets 22 are sensors configured to detect the movement. The sensors are further configured to transmit the detected movement to a control unit 90.

In other examples, the network 20 includes an emitting device such as but not limited to a laser interferometer and a camera that are configured to determine the movement based on detected data.

Some examples include a single network 20 to monitor the structure 50. Other examples include two or more different networks 20 with each network configured to monitor a different section of the structure 50. In systems that use multiple networks 20, the networks may be the same or different.

The network 20 has a sampling rate to capture the movement of the structure 50. In some examples, the sampling rate is adequate to capture a vibration signature of the structure 50. In some examples, the network 20 is configured to collect data at frequencies up to 1,000 Hz.

In some examples, the laser trackers 21 are mounted at a fixed position relative to the structure 50. In other examples, the laser trackers 21 are movable relative to the structure 50. In some examples with movable laser trackers 21, one or more targets 22 are positioned on the floor on which the laser trackers 21 move. These targets 22 are stationary to track the motion of the laser trackers 21.

Other examples include the use of other measurement methodologies such as photogrammetry with the use of high-speed cameras and circular targets (contrast or reflective). The various examples include an adequate sampling rate to capture the images of the cargo 80 as it moves through the vehicle 100. In some examples, the Nyquist–Shannon sampling theorem is applied to avoid aliasing.

The data from the sensing network 20 is processed by a control unit 90. The control unit 90 is configured to determine the extent of movement of the structure 50. The control unit 90 includes the position of the targets 22 relative to the structure 50 and receives the data from the network 20 to determine the movement of the structure 50. The movement can include various aspects that occur to the structure 50 during the parallel work. The movement of the targets 22 can be monitored in different manners. In some examples, the movement includes displacement. Examples include one or more of displacement, velocity, and acceleration in one or more of an x-direction, y-direction, z-direction, and xyz magnitude. In some examples, the targets 22 are monitored for the same type of movement. Other examples monitor different targets 22 for different type of movement (e.g., velocity is monitored for a first target and displacement is monitored for a second target). Likewise, the threshold can include one or more different characteristics of the movement, including but not limited to one or more of displacement, velocity, and acceleration in one or more of an x-direction, y-direction, z-direction, and xyz magnitude.

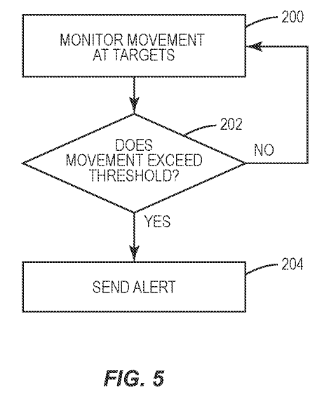

In some examples, the control unit 90 determines the movement based on the raw data received from the network 20. FIG. 5 illustrates one example of monitoring the movement of the structure 50. The control unit 90 monitors the position of the targets 22 as work is being performed on the structure 50 (block 200). In some examples, for each of the targets 22 the control unit 90 determines a distance the target 22 moves away from a baseline. The baseline is the position of the structure 50 at the target 22 prior to work being performed on the structure 50. In some examples, the baseline is determined when no work is being performed anywhere on the structure 50. In other examples, the baseline is determined when no work is being performed within a predetermined vicinity of the target 22. In other examples of monitoring the movement, the control unit 90 determines a distance each of the targets 22 has moved within a predetermined time period.

The control unit 90 determines if the detected movement exceeds the threshold (block 202). If the movement does not exceed the threshold, the control unit 90 continues to monitor the movement. If the movement exceeds the threshold, the control unit 90 causes an alert to be transmitted (block 204).

In some examples, the raw data is processed to calculate an acceleration. FIG. 6 illustrates a plot of displacement of a target 22 over time. The length of the time over which the displacement is measured can vary. In some examples, the system is constantly measuring displacement. In other examples, the displacement is measured at discrete time periods, such as when work is being performed on the structure 50.

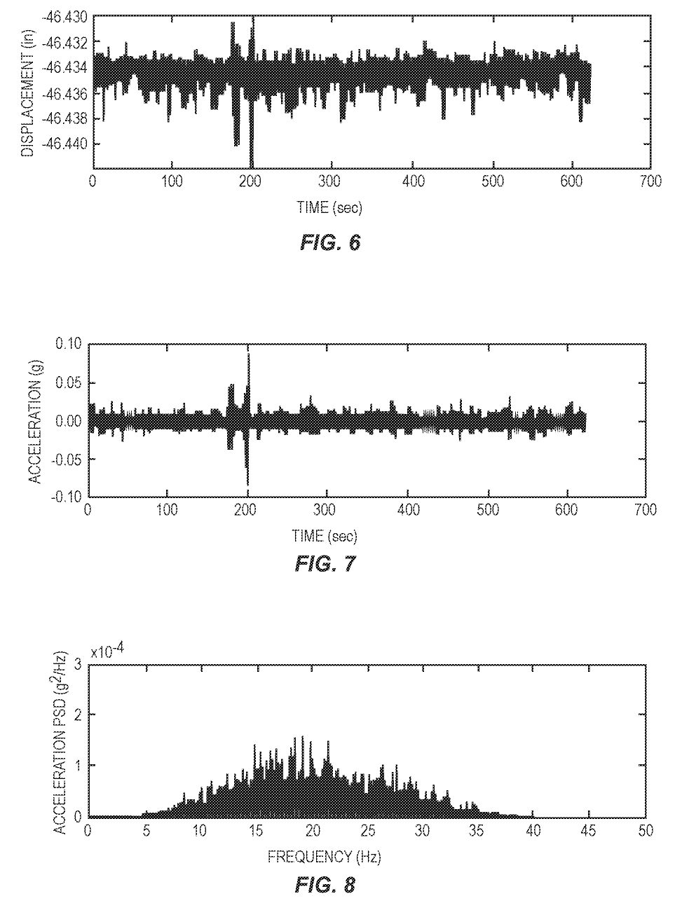

In some examples, the raw displacement signal is plotted along with a second derivative of the raw data to obtain acceleration. FIG. 7 illustrates the raw displacement data of FIG. 6 converted into acceleration and plotted in units of acceleration (i.e., g units) over time. In some examples, the control unit 90 analyzes this acceleration data to determine whether the one or more thresholds are exceeded.

In some examples, the data analysis further includes performing a frequency analysis on the acceleration data. The frequency analysis converts the time-domain acceleration data into a frequency domain using a Fast Fourier Transform (FFT) algorithm. The analysis computes a Power Spectral Density (PSD) since the data was collected over longer periods of time and the structure was potentially exposed to many random vibration frequencies that occur within a factory setting. The PSD uses the amplitude of the FFT which is multiplied by the complex conjugate and normalized to the frequency bins. This calculation normalizes the frequency strength relative to the frequency range and not over a time range. FIG. 8 illustrates the acceleration data of FIG. 7 output as a plot of the PSD. In some examples, analysis of the movement data using the PSD is a more accurate way to compare multiple random frequency signals.

The data analysis can include the movement of sections 51 of varying sizes. In some examples, a section 51 includes the data from a single target 22 to determine the movement. Because the location of the target 22 relative to the structure 50 is known, the location of the movement is likewise known. In other examples, two or more targets 22 are monitored to determined the movement of a section 51. In some examples, the data from the targets 22 are combined together and analyzed. This combination of data enables analyzing a larger area of the structure 50. One example includes analyzing data from a group of targets 22 located within a known section 51 of the structure, such as a component that has been attached to a larger component on the structure 50. When data from multiple targets 22 are combined together the thresholds to determine excessive movement may be the same or different than the thresholds used with data from a single target 22.

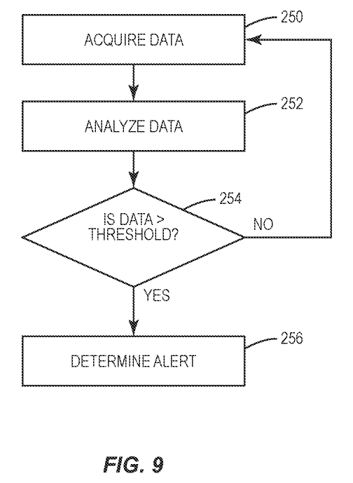

FIG. 9 illustrates a method of monitoring movement of a structure 50. The method includes acquiring the movement data from one or more targets 22 (block 250). The movement data is then analyzed (block 252). In some examples, the analysis includes computations to determine movement in one or more of the time domain and frequency domain. In some examples, the analysis includes computing the acceleration in one or more directions and magnitudes. In some examples, the magnitude of the acceleration is computed in three dimensions (e.g., x, y, z). Frequency analysis of the acceleration data is performed via FFT and a PSD is computed.

The method further determines if the data exceeds one or more thresholds (block 254). If the thresholds are not exceeded, the process continues. If the data exceeds one or more of the thresholds, an alert is determined (block 256).

In some examples, the control unit 90 identifies noise in the data. The noise is removed or attenuated prior to the data being analyzed. The noise can be caused by various conditions, including but not limited to conditions within the work zone (e.g., HVAC), people moving within the work zone, various occurrences in a manufacturing environment (e.g., crane movements, hangar door opening/closing, material handling. In some examples, the noise is the baseline data from the network 20 that occurs prior to work being performed on the structure 50. In one example, the baseline data is obtained at a time when no persons are in the work zone and no work is being performed on the structure. One specific example includes obtaining the baseline at night when there are no workers in the area surrounding the structure 50. The control unit 90 removes the noise prior to analyzing the data.

The data analysis uses one or more different thresholds. In some examples, multiple thresholds are established based on the different amounts of movement. A first threshold can indicate a relatively minor amount of movement that does not prevent the process from continuing. A second threshold indicates a large amount of movement and requires stopping the process. One or more intermediate thresholds can also be established, such as movement that requires the process to operate at a slower speed but otherwise can continue on the structure.

In some examples the one or more thresholds are the same throughout the structure 50. In other examples, the control unit 90 determines the requirements for each of the two or more processes that are being performed in parallel on the structure 50. The different processes can have different requirements and thus have different thresholds. For example, a first process being performed requires precise placement of equipment (e.g. drilling) and therefore has a more stringent threshold. A second process being performed in parallel has just coarse movements (e.g., tightening fasteners) and has a less stringent threshold.

The control unit 90 is configured to send an alert when a threshold is exceeded. The alert can include various configurations. The alert can be a communication indicating the issue. The communication can be sent to one or more entities, including but not limited to a technician performing the process, a person overseeing the work on the structure, and a remote node 59. Additionally or alternatively, the alert can include stopping one or more processes or equipment. In one example, the control unit 90 is configured to prevent one or more pieces of equipment from operating when the threshold is exceeded.

In some examples, the control unit 90 uses a single threshold to determine if an alert should be sent. In other examples, multiple thresholds are established indicating different degrees of movement. For example, a first threshold indicates a relatively small amount of movement of the structure 50. Exceeding the first threshold results in the control unit 90 sending a first type of alert, such as a notification for a technician to be aware of the movement but otherwise enabling the process to continue on the structure 50. A second threshold indicates a relatively larger amount of movement of the structure 50. The control unit 90 sends a different more aggressive alert when the second threshold is exceeded. For example, the second threshold may stop the equipment from operating to prevent work from being performed on the structure 50.

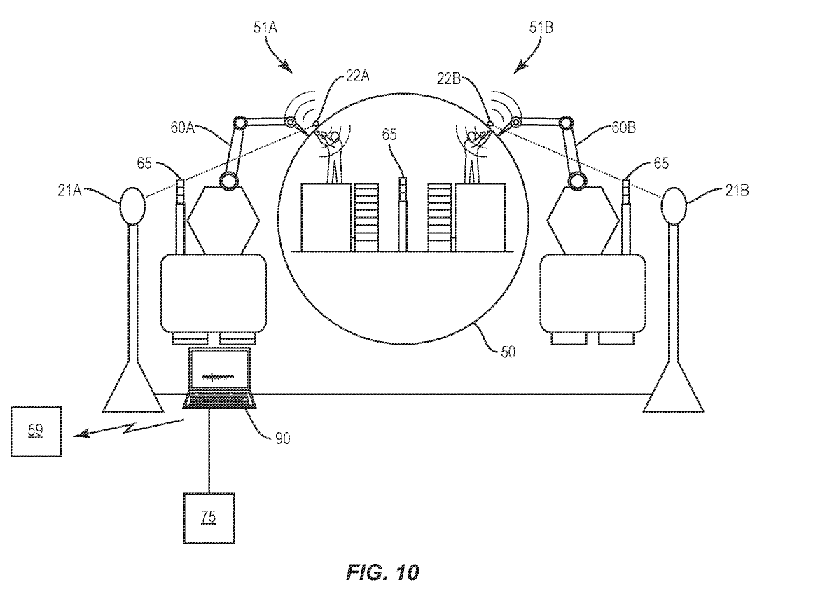

FIG. 10 illustrates a work environment with a structure 50 in which parallel work is being performed on different sections 51A, 51B. A first process using first equipment 60A is being performed on the first section 51A. A second process using second equipment 60B is being performed on the second section 51B. In this example, each of the processes include equipment 60 on the exterior of the structure 50 with technicians positioned within an interior of the structure 50 to monitor the process.

One or more targets 22A, 22B are positioned on the structure 50 at the respective first and second sections 51A, 51B. Laser trackers 21A, 21B are configured to detect the respective targets 22A, 22B. A control unit 90 receives the movement data through the laser trackers 21A, 21B.

The work environment also includes one or more indicators 65. In this example the indicators 65 include lights with different sections (e.g., red, yellow, green) that are illuminated based on the detected movement.

The control unit 90 receives and analyzes the movement data. When the control unit 90 determines that the movement is below the threshold, the control unit 90 causes the indicators 65 to display a first output. One example includes illuminating a green light to indicate to the technicians that the processes can continue. Other examples include sending an electronic signal to the other automated machinery or robotic hardware that is working in parallel. When the control unit 90 determines that the movement is above the threshold, the alert is sent to indicate the issue. In some examples, the control unit 90 causes the indicators 65 to display a second output, such as a red light. The second output indicates to the technicians that the work should stop due to the excessive movement of the structure 50. Additionally or alternatively, the control unit 90 stops operation of the equipment 60A, 60B thus preventing the processes from continuing. In some examples, the control unit 90 is configured to analyze the movement data relative to one or more intermediate thresholds. In one specific example, exceeding an intermediate threshold results in a yellow light being displayed on one or both of the indicators 65.

In some examples, the control unit 90 sends an alert to each of the various components of the system at the structure 50. For example, each of the indicators 65 displays a red light when the threshold is exceeded. In other examples, the control unit 90 sends an alert to just a limited section portion of the system that is affected by the excessive movement. For example, the alert is sent to just the components at the first section 51A such as the adjacent indicators 65 and/or equipment 60A. The alert is not sent to the other section 51B. This may be because the different sections have different thresholds based on the type of process that is being performed and the threshold is just exceeded at the one section (e.g., the first section 51A) and not at the second section 51B. For example, a first process having precise positioning requirements may exceed a threshold and result in a first alert being sent to that section of the structure 50, while a simultaneous second process with broader requirements may not cause an alert or may cause a lower alert.

The acquired data can be used to determine the cause of the excessive movement in the structure. In some examples, historical data is analyzed and compared to the processes that are being performed on the structure at the time of movement. Specific work processes can be identified as causing an issue that needs to be addressed for future work processes. For example, analysis of the data determines that attaching ribbing to an interior side of a fuselage results in excessive movement of the fuselage. During the time that the ribbing is being attached, precise processes such as drilling should not be performed in parallel.

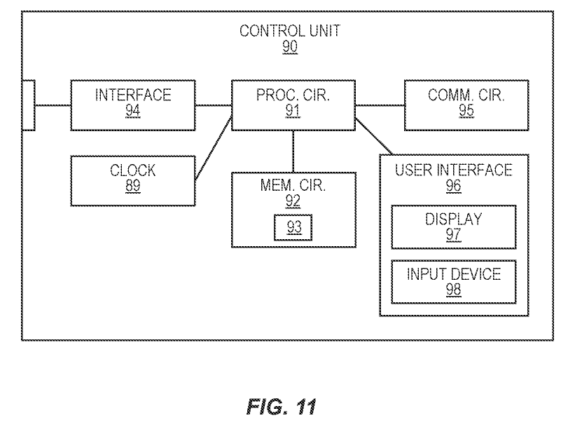

FIG. 11 illustrates a control unit 90 that includes processing circuitry 91 that operates according to program instructions 93 stored in memory circuitry 92. The processing circuitry 91 includes one or more circuits, microcontrollers, microprocessors, hardware, or a combination thereof. The processing circuitry 91 includes various amounts of computing power to provide for the needed functionality.

Memory circuitry 92 includes a non-transitory computer readable storage medium storing program instructions 93, such as a computer program product, that configures the processing circuitry 91 to implement one or more of the techniques discussed herein. Memory circuitry 92 can include various memory devices such as, for example, read-only memory, and flash memory. Memory circuitry 92 can be a separate component as illustrated in FIG. 11 or can be incorporated with the processing circuitry 91. Alternatively, the processing circuitry 91 can omit the memory circuitry 92, e.g., according to at least some embodiments in which the processing circuitry 91 is dedicated and non-programmable.

Interface circuitry 94 provides for sending and/or receiving signals from one or more of the components of the system. Components include but are not limited to the laser trackers 21, equipment 60, and indicators 65. The interface circuitry 94 can provide for one-way communications or two-way communications that are both to and from the components. Communication circuitry 95 provides for communications to and from the control unit 90 with a technician and remote node 59 (see FIG. 10).

A clock 89 tracks the timing of the data. A user interface 96 enables a user to control one or more aspects of the system during operation. The user interface 96 includes one or more input devices 98 such as but not limited to a keypad, touchpad, roller ball, and joystick. The user interface 96 also includes one or more displays 97 for displaying information regarding the testing and/or for an operator to enter commands to the processing circuitry 91.

The control unit 90 is also communicatively coupled to one or more processing nodes 75 (see FIG. 10). The processing nodes 75 are accessed to determine the various processes that are being performed on the structure 50. This can also include the time period during which the process is to be performed, the location of the process on the structure, and various other information about the process. In some examples, the processing nodes 75 include the one or more thresholds that are used by the control unit 90. The control unit 90 is also configured to communicate the alert to a remote node 59.

The movement data is stored at the control unit 90 and/or at a remote node 59 such as a database. The movement data can be used to determine a cause of a processing issue that is determined at a later time. The movement data is time stamped and in the event an issue is determined about a specific aspect of the process (e.g., the size and/or position of a hole that is drilled in a section of the structure 50), this historic data can be analyzed to determine the extent of movement of the structure 50 that occurred at that position at that time.

The movement data is also used to attribute movement characteristics to certain tasks. For example, the movement data can indicate certain frequency characteristics that occur during certain processes. Based on the analysis, processes can be changed to prevent any potential issues from occurring due to movement of the structure 50 during these types of processes.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of monitoring a structure while parallel work is being performed on the structure, the method comprising:
acquiring data at a plurality of points on the structure while the parallel work is being performed on the structure;
analyzing the data and determining movement of the structure; and
sending an alert when the movement of the structure exceeds a threshold.

2. The method of claim 1, further comprising:
acquiring the data at a plurality of points at least at a first section and a second section of the structure;
analyzing the data and determining the movement of the first section of the structure; and
sending the alert when the movement of the first section of the structure exceeds the threshold.

3. The method of claim 2, further comprising after sending the alert stopping the work that is being performed at the first section of the structure and continuing the work that is being performed at the second section.

4. The method of claim 1, further comprising placing targets at the points on the structure and acquiring the data at the plurality of points using the targets.

5. The method of claim 1, further comprising calculating an acceleration and a frequency of the movement of the structure.

6. The method of claim 5, further comprising:
calculating the frequency through a Fast Fourier Transform; and
calculating a Power Spectral Density.

7. The method of claim 1, wherein the threshold is a first threshold and further comprising comparing the movement to the first threshold and a plurality of escalating thresholds and determining which of the one or more thresholds is exceeded.

8. The method of claim 1, further comprising:
subsequently determining an issue within the structure caused during the parallel work; and
identifying a cause of the issue based on data on the movement.

9. The method of claim 1, wherein sending the alert comprises preventing the work from being performed at a first section of the structure.

10. A method of monitoring a structure, the method comprising:
acquiring data at a first section of the structure while work is being performed on both the first section and at least one additional section of the structure;
determining movement of the first section of the structure based on the data;
determining that the movement of the first section exceeds a threshold; and
sending an alert when the movement of the first section exceeds the threshold.

11. The method of claim 10, wherein the at least one additional section is spaced away from the first section on the structure.

12. The method of claim 10, wherein determining the movement of the first section of the structure comprises determining a vibration of the first section.

13. The method of claim 10, further comprising:
calculating an acceleration of points in the first section; and
calculating a power spectral density of the points in the first section.

14. The method of claim 10, further comprising sensing the movement of the first section at a point at the first section.

15. The method of claim 10, wherein sending the alert comprises displaying a signal on an indicator that is positioned at the first section.

16. A control unit that monitors movement of a structure, the control unit comprising:
processing circuitry; and
memory circuitry comprising programming instructions that are executable by the processing circuitry whereby the control unit is configured to:
acquire data at a plurality of points at a first section and one or more additional sections of the structure while parallel work is being performed on the first section and the one or more additional sections;
analyze the data to determine the movement of the structure within the first section of the structure;
determine that the movement of the structure within the first section exceeds a threshold; and
cause a change in the work that is being performed on the first section.

17. The control unit of claim 16, wherein the control unit is further configured to:
calculate a frequency of the movement of the first section; and
calculate a power spectral density of acceleration.

18. The control unit of claim 16, wherein the control unit is further configured to send an alert after determining that the movement of the structure within the first section exceeds the threshold.

19. The control unit of claim 16, wherein the control unit is further configured to calculate an acceleration and a frequency of the movement of the structure within the first section.

20. The control unit of claim 16, wherein the control unit is further configured to:
determine an issue with the work that has been performed on the first section;
determine data on the movement that was recorded while the work was being performed on the first section; and
determine a cause of the issue based on the movement data.
